(19) United States
(12) Patent Application Publication
(10) Pub. No.: US 2012/0244504 A1
(43) Pub. Date: Sep. 27, 2012

(54) SYSTEM FOR THE SYNCHRONIZATION AND PROPAGATION OF HEALTH BEHAVIORS AND MANAGEMENT OF RELATED INCENTIVES

(76) Inventor: Neil H. Wasserman, Belmont, MA (US)

(21) Appl. No.: 13/429,297

(22) Filed: Mar. 23, 2012

Related U.S. Application Data
(60) Provisional application No. 61/457,424, filed on Mar. 23, 2011.

(51) Int. Cl. G09B 19/00

(52) U.S. Cl. 434/238

(57) ABSTRACT

A web, server, and mobile device-based system to aggregate individual health activities into simpler behavioral modules and manage the social propagation, synchronization, and incentivization of such behaviors in a networked population. The system and implemented methods addresses the failure of current behavioral change techniques to achieve persistent engagement with behavior change through a systematic reduction in complexity of information and decision-making burdens on individuals to manage such behaviors. The system aggregates individual behavioral events into modules called, Walks, and provides mechanisms to synchronize and other individuals through a structured group hierarchy and shared events designed to propagate such behaviors across the participating population. These mechanisms enable network efficiencies that amplify the effectiveness of particular material incentives through social synchronization and reinforcement mechanisms. The methods and systems that apply to physical health are generalized provide an integrated capability to manage behaviors related to financial health, workplace practices, and social engagement.

### CROSS-REFERENCE TO RELATED APPLICATION

This application is entitled to the benefit of U.S. Provisional Application 61/457,424, filed on Mar. 23, 2011.

### PRIOR PUBLICATION DATA

### Related U.S. Application Data

U.S. Provisional Application No. . . . 61/457,424, filed on Mar. 23, 2011.

U.S. Cl.

482/9, 482/1, 705/319, 705/14

Fields of Classification Search

482/1-9, 705/14, 705/2, 705/319,

See application file for complete search history.

### REFERENCES CITED

### U.S. PATENT DOCUMENTS

System and method for motivating users to improve their wellness awarded June 2011 2011/U.S. Pat. No. 7,967,731

Method for generating an on-line community for behavior modification Filed July 2004 US20060003305

Method for long-term behavior change in humans—Filed July 2005 US20060019225

Goals and Progress Tracking For Recovery Based Social Networking Filed July 2010 US20110046981

Device-Assisted Social Networking For Health Management filed November 2009 US20110118554

Methods and Systems for Health and Wellness Management February 2011 US20110196212

Method for Mediating Social and Behavioral Processes and Medicine . . . 1998 U.S. Pat. No. 5,722,418

System and Method for Providing Service or Adding Benefit to Social Networks 2008 US20100145771

System and Method of Economic Incentives That Foster Behavior Change to Improve Health 2007 US20070192195

System and Methods for Chronic Disease Management and Health Assessment 2007 US20070288266

System and Method for an Integrated Disease Management System 2006 US20080103814

Patient Interactive Healthcare Management 13-115,756 US20110270632 2011

### Other Publications

Neil H. Wasserman, “Managing Implementation Risks through Time-Behavior Analysis,” proceedings of the 2007 IEEE Conference on Technologies for Homeland Security. Published in IEEE Transactions.

Neil H. Wasserman, “Time-Behavior Models: A Conceptual Tool for Analyzing Decision-Making Options,” International Conference on Complex Systems, 2007.

R. Wing, et al., Lifestyle Intervention in Overweight

Individuals with a Family History of Diabetes, Diabetes Care, Volume 21, Number 3, March 1998

American Diabetes Association and National Institute of Diabetes, Digestive and Kidney Diseases, The Prevention or Delay of Type II Diabetes, Diabetes Care, Volume 25, Number 4, April 2002

Christian K. Roberts and R. James Barnard, Effects of Exercise and Diet On Chronic Disease, J Appl Physiol 98:3-30, 2005.

K. Baicker, et al., Workplace Wellness Programs Can Generate Savings, Health Affairs, February 2010.

### FIELD OF THE INVENTION

The present invention relates to analysis and management of human behaviors in relation to behavioral change and maintaining the persistence of such changed behaviors over time. The invention pertains to the management of wellness behaviors in large organizations and the implementation of systems to promote desired changes in consequential behaviors. The field of application includes preventive behaviors associated with physical health, and also behaviors pertaining to financial practices, workplace practices, and community engagement. The mechanisms described focus on the particular requirements for change in habitual behaviors described by “time behavior models” and the propagation and synchronization of such behaviors in networked social groups.

### BACKGROUND OF THE INVENTION

It is well known that lifestyle behaviors like diet, exercise, drug and alcohol addiction contribute to the likelihood of onset of chronic disease conditions, such as coronary, obstructive pulmonary disorder (COPD), obesity, heart disease, high blood pressure, and many cancers. In addition to causing much human misery, these conditions account for more than 70% of healthcare costs in the U.S. Consequently, a great deal of attention has been paid to behavior change strategies that may affect these conditions. Until recently most of the approaches to behavior change have been based on a one-to-one therapeutic model, practitioner (doctor/nurse) to patient. These approaches have included the “Health Belief Model,” “Theory of Reasoned Action,” “Theory of Planned Behavior, “Social Cognitive Theory,” and “Information Motivation Strategy Model.” These approaches have had limited success in changing behaviors in the short-term, and more limited success in producing lasting change in behavior. Patients may lose weight in the short-term, but typically regain the weight within a year, and then cycle up and down with deleterious effects.

One type of strategy to change behavior involves the use of incentives. Cash or cash equivalents are offered if subjects carry out beneficial activities, such as stopping smoking for a certain period or getting physical exams or diagnostic tests. Incentive strategies as currently practiced typically offer an material inducement that influences a decision to participate in a particular activity or behavior. The goal is to use the incentive to motivate a short-term action that may lead to a longer-term benefit. This is a response to the challenge that people have difficulty engaging in short-term actions, whose benefit is not realized until a distant point in the future. This is the case with many health-related preventive behaviors, such as controlling blood pressure.

Current models for behavior change recognize that specific incentives can produce beneficial feedback for individuals with regard to the adoption of behaviors that would otherwise be unattractive. The common model, which has persisted over decades, uses an individual therapist or coach to provide strategies and feedback to individuals with respect to short-term change in activities, such as exercise, medical interventions, and diet. Recent improvements in the art such as aim to automate features of coaching processes through enhanced communications, selective provision of information and messaging, and communications from personal coaching services and automated equivalents to coaching services. Initiatives such as telemedicine enhance efficiencies in how information is delivered to patients but do not change the fundamental model on which behavior change strategies are based.

Incentive models such as payments or penalties to change smoking behavior, for example, often work for a short period of time, but fail to achieve a persistent change. Weight is lost and then quickly regained. Such incentives, moreover, fail in a more dramatic way when multiple behavioral events, and distinct behavioral habits, must be carried out simultaneously by the individual. When an incentive is offered for a particular action, that inducement requires a decision-making process on the part of the subject/patient. The decision process in effect asks the subject to evaluate the value of the incentive relative to the cost of the desired action. In the typical incentive model, separate actions demand multiple decision-making processes on the part of the subject. Because the human capacity to pay attention to decision-making demands is limited, piling on multiple incentives results in decision-making fatigue and diminishing returns in terms of results. Existing practice has not addressed this key need to limit the cognitive demands placed on subjects for managing behavior change and responding to incentives. A second limitation in current approaches to incentives is the focus on material incentives at the expense of potentially powerful social pressures. The invention proceeds from an understanding that many wellness habits are in fact social behaviors.

The invention addresses these gaps and limitations of the current practice through a number of integrated techniques and mechanisms designed to provide new approaches to the management of habitual behaviors, which address deficiencies in current wellness approaches. These techniques provide new ways to aggregate wellness activities into modular units called “Walks” which have special properties that permit rule-based mechanisms for propagation of desired behaviors within a large population, such as the employees of large-scale employer organization. The properties of these Walks enable structured incentives that are more efficient than current incentive strategies for behavior change. The new approach facilities efficient communication, adoption, and propagation of desirable behaviors across large social groups, including the employee population of a large company or other organization. The invention meets several requirements that current practice fails to address: 1) the need to reduce and simplify informational requirements and decision-making demands on individuals in the wellness program; 2) the need to translate long-term benefit into shorter-term incentives; 2) the need to integrate change in physical health and other behaviors such as those related to financial wellness, employee engagement, and social responsibility; 3) the need to customize incentive and wellness strategies based on documented risks and psychographic metrics; 4) the need to make use of groups and social pressures to persist in desired behaviors; the 5) the need to vet behaviors and the depth change strategies based on experimental data and member compliance history.

### BRIEF DESCRIPTION OF THE DRAWINGS

FIG. 1 describes the context for the operation of the Synchronized Health Incentive Platform (SHIP) including direct users of the system and indirect stakeholders who benefit from behavior change by participating members.

FIG. 2 describes the main functions carried out by the SHIP Software and the relationships among set of functions to the participating member.

FIG. 3 is a block diagram showing the top-level menu structure of the SHIP Software.

FIG. 4 is a block diagram describing the behavior selection process according to the Walk-Path-Destination Model implemented in the invention.

FIG. 5 is a block diagram of the process for behavior scheduling and customization.

FIG. 6 shows an image of the web application with the Annual Walk View, illustrating the manner in which individual walk modules are synchronized in relation to the annual calendar.

FIG. 7 shows an image of the web application with the Weekly Walk View, showing the weekly schedule of events, which the member has agreed to carry out as a result of the Walk Selection Process.

FIG. 8 shows a view of the Group Dashboard, with access to member information, messages, and discussions for the Walk Groups, Path Groups, and Destination Groups in which the member participates.

FIG. 9 is a block data diagram of the overall system architecture showing client-side devices, server-side devices, communications interfaces and access to external services.

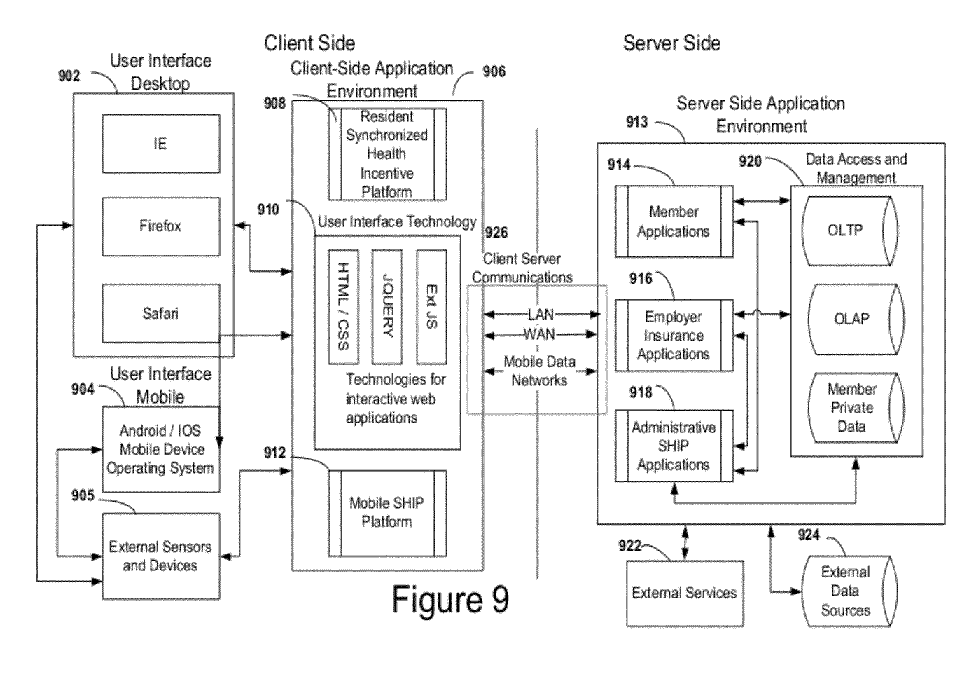

FIG. 10 is a block diagram of system modules, including those that support aggregation functions, synchronization functions and incentive management functions.

FIG. 11 is an image of the Main Dashboard, Which which provides real-time updates of information critical to member participation, including the status of the member's Walks, connections to other members and groups, and the status of challenges and competitions.

FIG. 12 is a block diagram showing the Village Metaphor, which provides an intuitive interface for member participation in selected behaviors, games and competitions, reward redemption, and other functions.

### BRIEF SUMMARY OF THE INVENTION

Time behavior analysis is a set of techniques used to model habitual behaviors such as those involved with wellness programs. These techniques permit the description of behaviors in terms that distinguish one-time behaviors (tØ behaviors) from behaviors that have events linked in a time-series (t1-behaviors). The time-behavior viewpoint also permits that analysis of t1-behaviors that are propagated in a network, i.e. across a population. The invention describes a set of methods and technologies that can be used to implement such behavioral models to address the needs for adoption of wellness behaviors in an organization with a substantial number of employees. The invention, embodied in the Synchronized Health Incentive Platform (SHIP) involves a number of mechanisms to synchronize multiple t1-behaviors (wellness habits) for an individual employee. The systematic implementation of these techniques (the SHIP Program) permits generalizing the domain of application from physical health to financial health, workplace practices, and social responsibility. The invention addresses requirements for synchronizing the behaviors across social groups and the larger organization as a whole. The invention enables a synchronized view of individual and group calendars permitting social awareness of individual progress and the implementation of mechanisms of communication and support among individuals and groups that support persistence of behaviors and amplify the efficiencies of individual and group incentives to achieve desired objectives.

The behavioral model and its implementation enables 1) Aggregation of multiple behavioral events or activities into manageable cognitive units (Walks), 2) Synchronization of behaviors for individuals and groups within standardized Walk Periods, and 3) Propagation of behaviors across the network structure implemented by the invention in relation to individuals and groups. The techniques for aggregating behavioral events and synchronizing behaviors within population groups radically reduce the information required to manage the behaviors and reduces the decision-making demands on individual members of the Program. Hereafter, we will refer to this as the Program or, meaning the set of methods and procedures prescribed in the specification and the supporting software programs, algorithms, and devices, as described in the detailed description of the invention. With this foundation the invention implements methods and mechanisms to apply multiple incentives (material and social) to individuals and groups in the Program. The multiple incentive pressures, including games and competitions, to enable individuals to respond to group social influence as well as to material incentives, increase the likelihood that behaviors will persist and become internalized in individual habits and group culture.

The invention recognizes the need to customize behavior selection and incentive strategies based on individual risk assessment. The invention implements various rules engines to guide behavior selection and incentive rewards to respond to individual needs. The invention provides for realtime data gathering and reporting on compliance of participating members to behavioral commitments. Finally, the invention implements capabilities to design experiments in selected participant groups. Such experiments to test alternative messaging, incentives, and motivational techniques permit continuing improvement of strategies to promote increasingly effective use of resources to achieve wellness objectives.

### DETAILED DESCRIPTION

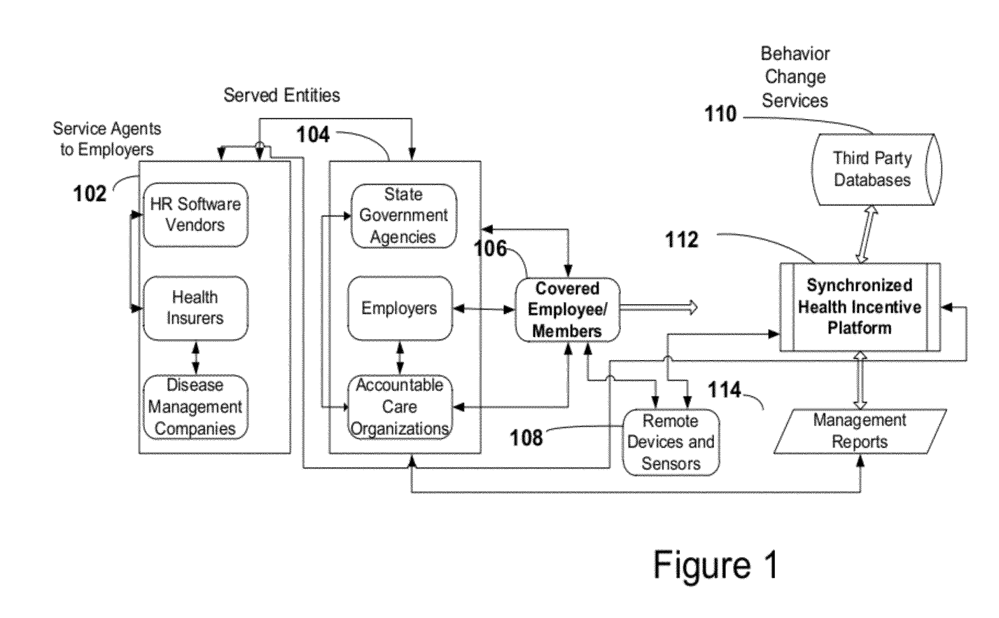

The invention consists of apparatuses, devices, methods, and processes that form a system designed to alter existing behaviors, implement new behaviors, and support the persistence of behaviors that promote the long-term health and well-being of program participants. In the typical embodiment, The SHIP Program (hereafter, the Program) is implemented in an organization (Served Entities [104]) in FIG. 1 with a substantial number of employees (in excess of 1000). The employer aims to carry out a program to implement behavioral change and reduce associated risk factors related to physical health, financial health, workplace practices, and social engagement. Such a program most commonly aims to encourage employees to adopt behaviors and carry out activities that improve health and reduce costs for treating current and prospective disease conditions. The SHIP Program (system and methods) can be delivered through multiple Service Agents [102], Human Resource (HR) software vendors, health insurers, disease management companies and others. The SHIP Program is also designed to be used by medical service providers, such as Accountable Care Organizations and hospitals to support essential behavior change regimens associated with follow-up care related to delivered medical procedures. The system integrates information from remote devices and sensors [108] and third party databases [110] to support intelligent adaptation of behavior change requirements to individual and group characteristics and requirements.

The invention extends the usual focus of wellness programs on physical health to include other dimensions of whole health, specifically, financial health, workplace practices, and level of social connectedness and engagement. In this specification, domains of physical health, financial health, workplace practices, and social engagement are referred to as the four dimensions of whole health. The extension of the methods for managing the adoption of physical health related behaviors to these other dimensions is an important feature of the invention. The invention permits the same unique behavioral model that is applied to physical health to be leveraged to these other dimensions, and in so doing, multiply the benefits to employers and employees.

The approach described in the invention is physically implemented as the “Synchronized Health Incentive Platform” and supporting software (SHIP Software) [112] in FIG. 1. The invention interacts through various communication channels and devices with other actors in the healthcare, financial services, workplace and social environment. These entities include: employees in the participating employer organization (hereafter referred to as “members”) [106], the employer organization; healthcare and human resources administrators in that organization; health insurers; research organizations in government agencies and universities; service providers in healthcare and behavior change, financial management, workplace practices, and may include nonprofit service entities. In addition, vendors associated with delivery of incentive products and services may also be involved in the business environment of those who receive and supply data to the SHIP Software. The SHIP software may access third party databases [110] and data on employee progress to members, employers and other stakeholders [114].

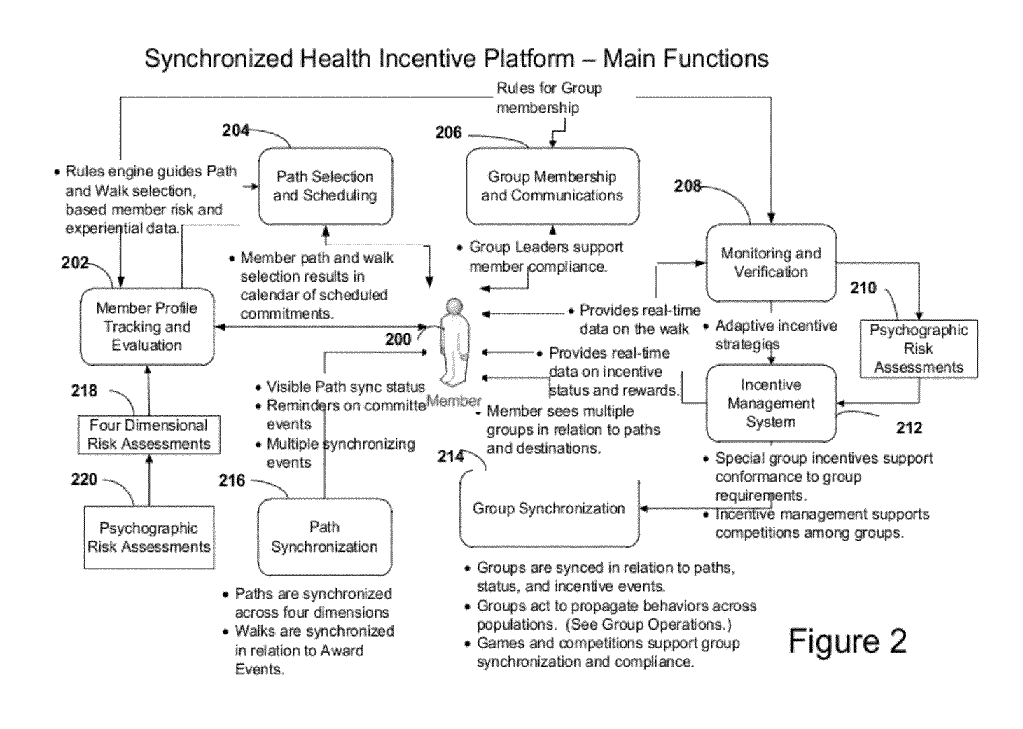

The overall operation of the SHIP Program and major functions are shown in FIG. 2. In contrast to existing approaches, which treat wellness activities, such as getting a physical exam, as an individual event which may be rewarded or incentivized, the Synchronized Health Incentive Platform aggregates such individual events into a longer-term behavior. Preventive behaviors that occur over the course of an annual cycle are treated as whole unit. This is then repeated on an annual basis. These aggregates are called Walks, a behavior cycle repeated in relation to a specific time interval. The preventive actions may include Prevention Check, Dental Checkup, Physical Exam, Scheduled Diagnostics (such as a required colonoscopy or mammogram), Dental Exam, vaccinations. The annual Walk is part of the Prevention Path, a long-term behavior that imposes certain requirements on the member. If these requirements are met the member receives a reward, delivered by the Incentive Management component of the Platform. As will be described subsequently, Walks are more typically used to describe aggregated behavioral events that occur on a shorter time cycle. Pill-taking at bedtime occurs on a daily cycle, and those daily events are aggregated into a Walk that in the preferred embodiment, extends over a two-month interval. This has the effect of reducing the information and decision-making burden on the participant.

The Platform is designed to conform to certain behavior management principles, described in [N. Wasserman, “Managing Implementation Risks through Time-Behavior Analysis,” IEEE Transactions.] The invention employs the concepts of Regularized Time Behaviors as described in the reference. This model of behaviors takes into account habitual behaviors that are triggered by clock cycles as well as networked social effects. The models described here differentiate between short-term one-off behaviors, such as downloading a particular article from the Internet, from behaviors that persist over time. These regularized time behaviors, also called T1 behaviors, are characterized by cyclic events that repeat on the particular time cycle. Examples include investments in a savings account that occur at the end of each pay period, or a 20 min. exercise walk that occurs on Mondays Wednesdays and Fridays. Regularized time behaviors carried out by individuals are called T1 behaviors. T1 behaviors that are propagated from a central point in an organizational network are called T2 behaviors. Finally, behaviors that are propagated from each node in an interconnected network are called T3 behaviors. The invention describes a set of mechanisms and system for implementing and applying this model of regularized, networked time behaviors to behavioral change in employee and other organizations.

The invention employs a unique “Walk-Path-Destination Model” to characterize behaviors using simpler terminology that captures essential characteristics of a regular time behaviors. Specifically, the term, Walk, is used to designate a set of activities carried out on a regular basis over a standard two-month time period. Members in the program commit to a finite Walk as an aggregate set of activities. Several Walks are then linked on a Path, which serve to meet the objectives associated with a “Destination.” The structural elements—Walks, Paths, and Destinations—are building blocks that permit synchronization of behaviors among individuals, groups, and leadership functions associated with the Walks, Paths, and Destinations.

The key components of Ship Software environment is described in FIG. 2.

The Member Profile Tracking and Evaluation Component [202] tracks member information, both shared and private, and supports processes for evaluating risks in the four whole health dimensions. On initiation into the program, the member is trained in the objectives, benefits, and processes involved in the program. The SHIP Program makes use of information in previously taken Health Risk Assessments (HRAs). If the member has not taken an HRA, the SHIP Program provides an HRA for the Physical Health dimension. In addition the SHIP Program provides HRAs for Financial Well-Being, Employee Engagement, and Social Responsibility. Another essential components of the risk evaluation process is the Psychographic Assessment [220], which provides metrics that describe the member's capabilities to carry out habitual (regularized time behaviors) within the SHIP Program model. These psychographic measures also act as predictive parameters for capabilities in propagating behaviors through leadership and communication activities. A rules engine uses internal data and external data sources to assess projected risks in relation to data gathered during the HRA process. The Synchronized Incentive Management Platform includes adaptive features to revise the psychographic measures in relation to actual experience of members in carrying out T1 behaviors.

The Path Selection and Scheduling Subsystem [204] uses the products of the HRA to guide the member through the Path Selection Process. The Path Selection Process provides a series of choice options for the member, that result in adoption of T1 behaviors that are synchronized in relation to other T1 behaviors within the member's Path portfolio. The Path Selection Process involves choosing a set of goals, the Destinations, from options within the four dimensional quadrants. For each selected Destination, the member is given a set of options based upon member preferences and capabilities revealed in the HRA. These options define potential Paths that reflect behaviors that, over time, produce measurable results consistent with the selected Destination. For example, the Destination of weight management may be associated with a Path involving dietary change and/or a Path involving exercise. The choice process then involves the selection of Walks which generally occur over a two-month period and reflect specific T1 behaviors that are carried out during the course of that time interval. The output of this process is a schedule reflecting the specific activities and time commitments associated with the selected Walks, Paths, and Destinations. This interval, about eight weeks in length is referred to as the “Modular Walk Period” or Walk Period. As will be discussed later, the use of the standard Walk Period is a key characteristic of the invention's methodology and is a key element of the methods supporting synchronization of behaviors and incentives.

The Group Membership and Communications Subsystem [206] manages the groups that support the adoption and persistence of wellness behaviors. Group operations and incentives are a key part of the motivational system for behavioral change and persistence. Individual members are automatically invited to join groups associated with Paths and Walks. There is a complementary set of obligations and benefits associated with group membership. Compliance with behavioral commitments results in specific group incentive awards, but individual members receive such awards only if the group requirements are met. Retaining membership and respect of other group members is a well-documented motivational force in the social psychological literature. The SHIP Software supports the visibility of group compliance and the award of such incentives. In addition the System supports communication facilities required to encourage group compliance and the ability of group leadership to encourage successful outcomes.

The Monitoring and Verification Subsystem [208] tracks actions of members and groups in relation to execution of individual behaviors, group compliance, and progress along defined Paths. The Monitoring System uses multiple devices, including medical instrumentation, mobile phones and devices, GPS monitoring, and other means of electronic reporting to record activities involved with member commitments. The SHIP System verifies compliance with formal lab tests and examinations and analysis of information from monitoring systems. These mechanisms complement group incentives to report on activities expeditiously and accurately.

The Incentive Management Subsystem [210] customizers incentive strategies and manages the delivery of incentives. Using information from the HRA, including psychographic measures, the Incentive Management System develops a customized incentive strategy for the individual member. The Incentive Management System applies a set of rules based on the member's selected Paths and Walks and other data that define member capabilities and motivations to determine specific incentives, messages associated with those incentives, and mechanisms for delivery of incentives. Following the criteria and incentive rules embedded in the Incentive Management System [212], members are awarded a certain number of points in relation to specific tasks and actions that have been accomplished. The Incentive Management System and translates these points into rewards The particular awards chosen are result of an interactive process between the member and the Incentive Management System. The rules associated with the Incentive Management System are designed to reward actions that promote the overall goals of behavioral persistence, propagation of behaviors, and social support for the member's individual behaviors and the role of members in supporting the adoption and persistence of behaviors associated with other members and groups. Both rules for analyzing incentives and actual incentives applied to individual members are adapted in relation to member and group experiential data.

The Group Synchronization Subsystem [214] addresses the manner in which group behaviors and actions are coordinated and made visible to group membership and administrators of the SHIP System. The Groups associated with desired persistent behaviors act as an important mechanism for propagation of behaviors across populations. Because of the regularity of the Walk time periods (typically two months in length, six times per year), events associated with Walk groups, such as Incentive Award Events, can be arranged to highlight social relationships within and among groups. The members within a Walk group have adopted similar behaviors that characterize membership in the group. These behaviors, linked to the same clock cycles, are synchronized within the Groups and are reinforced through intragroup communications. The Group incentive awards, given for Group performance in relation to individual Walk commitments, encourage awareness on the part of Group members of other members' behaviors. Group Leads act to monitor individual behaviors within the Group Lead's Walk group, and encourage those who may be having difficulty to get back on track. Games and competitions between groups also act to synchronize group behaviors and propagate information related to behaviors from one group to another. Path groups, which may have multiple Walk groups as subgroups, oversee the types of behaviors that fall within the Path subject area. For example, Walk groups having to do with Low-Salt Diet, Blood Pressure Medication, and Meditation may belong to a path associated with Blood Pressure Control. The SHIP Software makes the member aware of the multiple groups to which the member belongs and aware of the status of the groups in relation to prospective rewards.

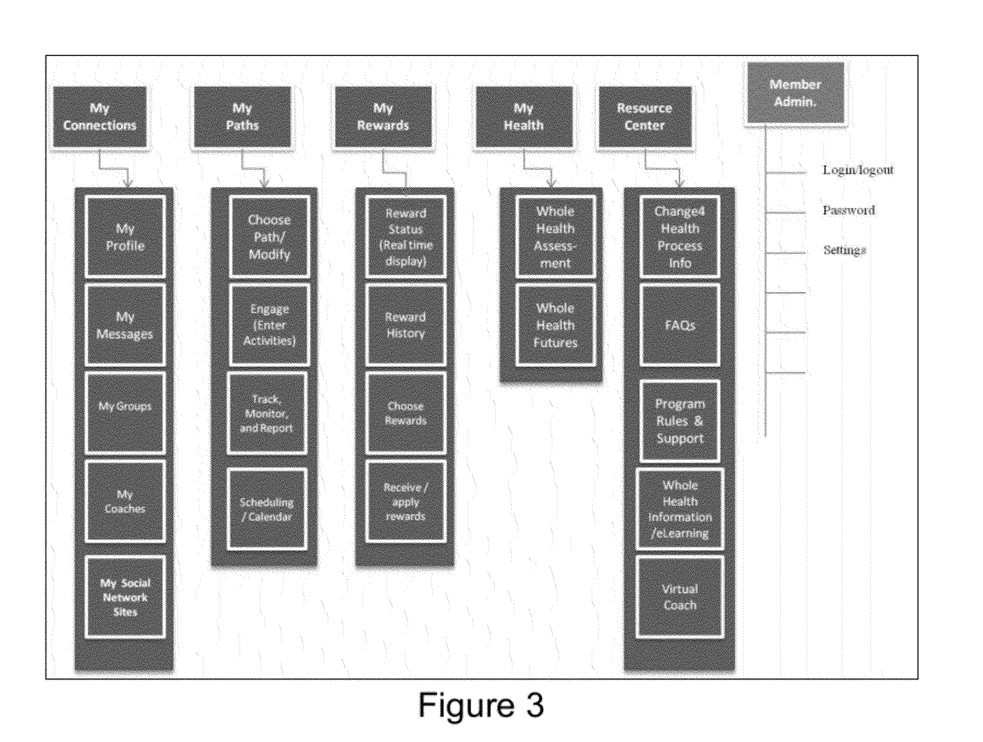

The Path Synchronization Subsystem [216] ensures that Paths are coordinated across the four dimensions. Each Path, such as Aerobic Exercise, may be associated with more than one Destination. The Path will have a Path Group Lead, who will act to coordinate the multiple Walks associated with the particular Path. The Award Events act to coordinate incentives across multiple Walks and Paths. The gauges make progress along Paths visible to individual members and to the members of Path Groups. Integrated calendars show the member's progress along the multiple paths to find in the member's current program. Paths may be associated with more than one Destination. But the Walks associated with the multiple paths associated with a given Destination are synchronized in terms of common ending periods (also associated with Award Events). The common synchronization points and award events at the end of Walk periods are illustrated in FIG. 3. One of the key features of the invention is the use of a common calendar and regular periodic events to ensure that member progress along a Path receives recognition from a larger social group.

System Operations and Process

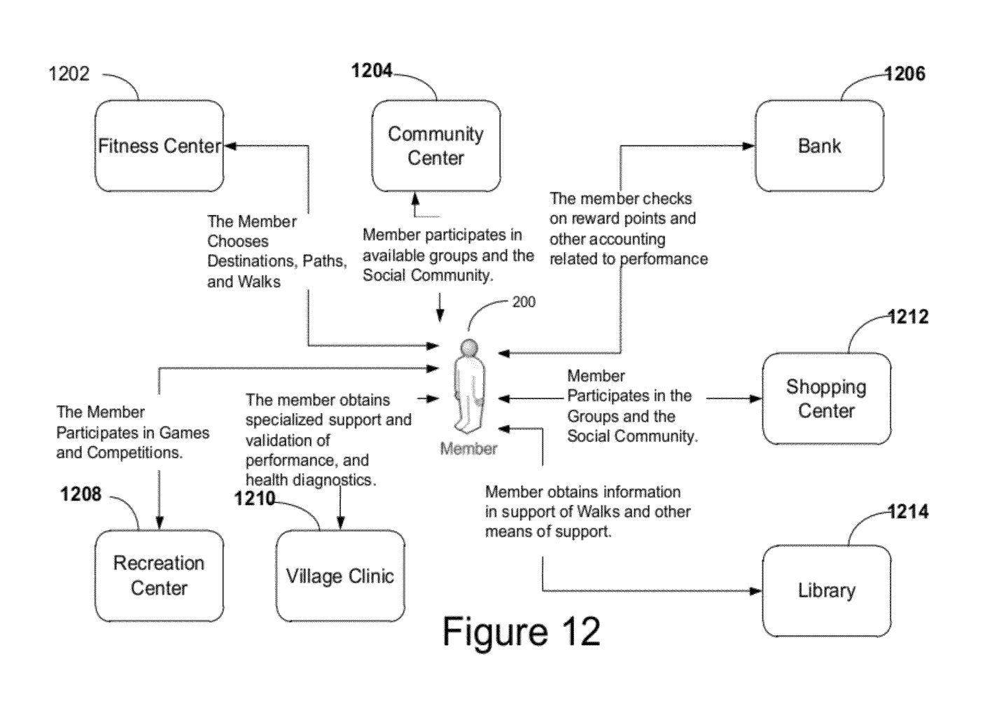

The overall operation of the system consists of the following steps. The user opens the SHIP Software application on the desktop, laptop, or other device. In certain environments the application may be continuously running in the background providing the user with an icon to access application functions. The user/member carries out required logon steps, entering his/her username and password. Access security may be enhanced with a biometric identifier. The user then sees the “Homepage” which provides access to major SHIP Software functions. These functions provided on a top-level menu [FIG. 3] include: access to the member's connections, access to the member's paths, access to reward functions, access to information on the member's health. The menu also includes a menu for resources that support the member in using the SHIP Software and its behavior management functions. This menu reflects one embodiment of the functional design, easily implemented in a web-based application interface. Other embodiments, such as that implemented on a mobile device, includes a simpler set of functional options. The Village Metaphor, Shown in FIG. 12, provides an additional illustration of the manner in which the core functions of the SHIP Software can be adapted to particular user requirements.

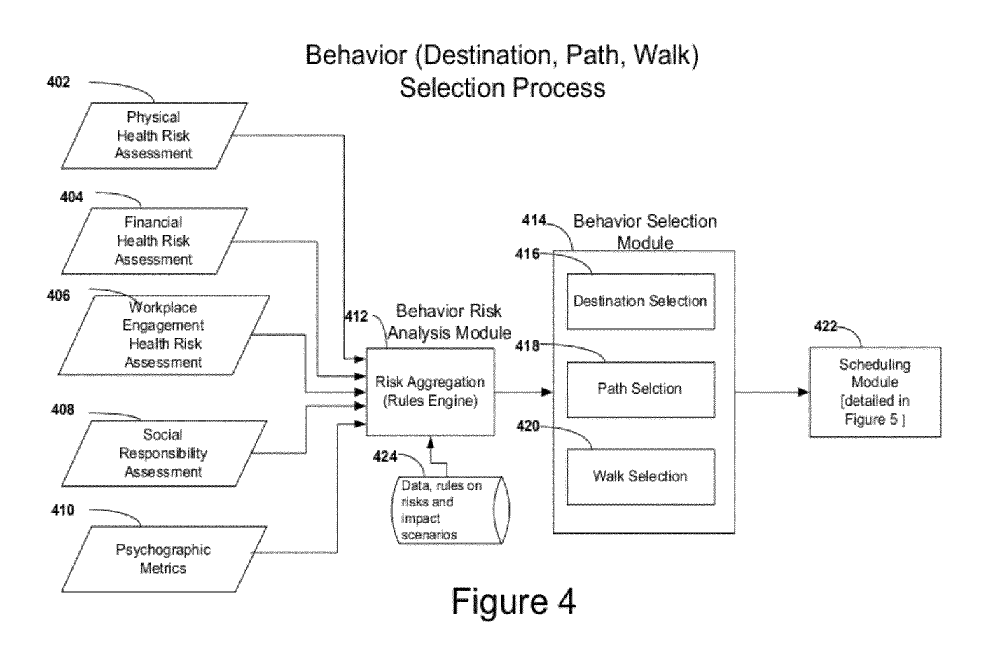

As shown in FIG. 4, when the prospective member uses the system for the first time, the member goes through an initiation process in which Health Risk Assessment (HRA) [402, 404, 406, 408, 410] is carried out to identify wellness behaviors that can have the greatest effect on the member's health outcomes. This assessment is performed in relation to the four dimensions of whole health—physical health, financial health, workplace empowerment, and social engagement, each producing a data set on risks it is relevant to the identified dimension. Each of these dimensional assessments produces an Aggregate Risk Metric (ARM).

There is a fifth category of data [410], which measures the capabilities of the individual member to carry out sustained cyclic behaviors (routines) designed to have an incremental impact on identified health risks. These “psychographic measures,” such as the ability to carry out regular training, postpone gratification, and respond to the encouragement of team members and coaches inform subsequent steps in the path selection process. The psychographic measures assess the member in specific categories: Economic Level, Education, Language, Self-perceived Level of Health, Self-Efficacy, Health Knowledge, Habitual Behavior, Risk Proclivity, Time Preference, Social Conductivity. These measures inform many aspects of the behavior selection process and requirements for supporting the member in persisting in the adopted behaviors.

The psychographic assessment also results in an aggregate measure, called the Affinity for Behavioral Change (ABC metric). The initial Health Risk Assessment provides aggregate measures (ARMs) in each of the dimensions and for the Affinity for Behavior Change metric. These initial measures provide a baseline which can then be tracked against subsequent measures of the member's capabilities. The initial baseline measures and subsequent data provide a mechanism for measuring SHIP Program impact on individual members and identified population groups. Because the system is designed to improve the member's capabilities to adopt habitual or regularized time behaviors, the ABC metric can provide feedback on progress in this domain.

The Risk Aggregation Module [412] assesses data from the risk assessments and applies rules and knowledge of the efficacy of medical regimens in relation to identified risks to determine individualized behavioral recommendations. The goal is to propose Destinations, Paths, and Walks appropriate to the psychographic profile of the individual and opportunities to realize benefit in terms of reduced healthcare risks, costs, and related opportunities in the other dimensions.

The selection of Paths [418], following the SHIP Program methodology, involves the choice of behaviors that will persist over an extended period of time. Based on the risk assessment the first step in this process is the selection of Destinations [416], which define goals for the persistent behaviors. Corresponding to the four dimensions of the HRA are Destinations corresponding to the four whole health quadrants. For each Destination there may be multiple behavioral paths that are carried out to produce measurable impacts with respect to health risks. These goals are measurable and are tracked by other processes. The rules engine [412] in the SHIP Software makes use of the psychographic information obtained in the HRA to recommend Paths appropriate to the individual member. The recommended Paths can then be customized to individual capabilities for managing regularized time behaviors and opportunities for reducing risk. Following the member's selection of the Paths, the SHIP Software recommends options for finite behavioral commitments called Walks. The Walks consist of regular behaviors that are carried out over the modular period, typically two months in length.

The structure of the Walks is designed to take advantage of the properties of regularized time-behaviors. The time behavior methodology establishes a mechanism to aggregate individual events into a regularized time behaviors. In the example of regular exercise for example, a member may be scheduled to carry out a weight-training several times per week. Under current practice, the individual is given an incentive for each time he/she exercises. This means that each event is treated as a separate incident, requiring a decision-making process to evaluate the value of the incentive relative the loss of time, and other perceived costs of carrying out the activity. Moreover, each event needs to be scheduled and possibly verified to see that the activity has in fact been carried out. In the environment proposed by the invention and supported by the SHIP Software, however, the individual activities are aggregated into a continuing behavior in which each individual exercise activity is linked to subsequent activities and grouped into a behavior taking place over the finite interval of the Walk period. This means that the major decision event is choosing to participate in the aggregated behavior, i.e., the Walk. The cognitive burden and complexity of scheduling individual events, and deciding on the desirability of individual events relative to incentives, is either eliminated or offloaded to the SHIP Software. The individual events are structured to be repeated at regular intervals implemented in the SHIP Software Walk schedule. The well-defined structure of the regularized time behavior ensures that only the minimum informational and decision-making burden is placed on the individual member. The member then follows the defined behavior for each activity and executes the recommended structure on the prescribed schedule. This schedule builds on the human ability to trigger repetitive behaviors based on internal and external clocks. Based on psychographic characteristics of the individual member, multiple incentives are applied to ensure that the individual stays on track with respect to the recommended behavior.

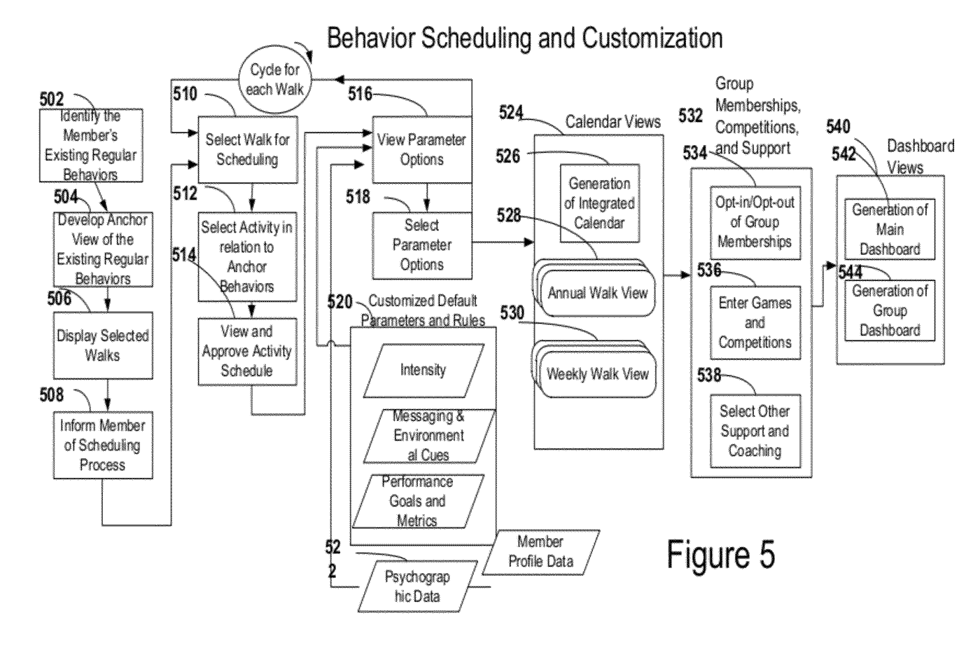

The scheduling of the Walk activities aims to meet several goals (see FIG. 5). The specific activities chosen by the member are voluntary commitments, which will be tracked during the course of the Walk Period. The resulting schedule must be simple to understand and easy to carry out. The specific customized characteristics of the Walk activities reflect the Psychographic Data and the member's preferences and capabilities. In line with the SHIP Program approach, the design of the Walk schedule aims to eliminate decision-making on the part of the member as much as possible, and increase the probability of persistence in the adopted Walk activities. Decisions on the nature of the activities are confined to the initiation into the SHIP Program and changes in the adopted Walk behaviors at the beginning of each Walk Period.

A key mechanism to encourage the persistence of engagement in the Walks is to associate the walk activities with both “clock triggers” and with existing regularized time behaviors (habitual behaviors that are carried out on a daily, weekly, monthly, annual basis). We call these existing time behaviors “Anchor Behaviors.” The identification of existing Anchor Behaviors can be carried out as part of the initiation process or in conjunction with the Behavior Customization and Scheduling Module shown in FIG. 5. The first step is to create a map of Anchor Behaviors [502]. The member identifies such existing behaviors from a menu of options, which may contain items such as waking behaviors mealtimes, regular work commitments, regular break times, etc. The creation of the Anchor Behavior Map serves several important functions. It shows the member how regular behaviors are already part of his or her daily functional routines. The Anchor Behavior Map also enables the member to attach new behaviors to existing behaviors and, in so doing, use old behavioral routines to trigger new ones. The member then sees a list of selected Walks [506] and is reminded of the steps involved in the scheduling process [508]. The member then carries out a cyclic process of selecting a particular Walk for scheduling and customization [510], and then repeating the process for each selected Walk.

The typical Walk is carried out on a weekly basis with one or more activities scheduled during the course of the week. The Scheduling Module [512] suggests options for weekly activities which can then be adjusted according to the members preferences in terms of timing and how those activities can be attached to an existing Anchor Behavior time schedule. In this way, and exercise activity can be attached to, for example, a lunchtime break and integrated within existing calendar. The member then approves the currently developed activity schedule [514]. The member is then given the ability to choose parameters that customize the activity. The member views the default parameter options [516], and selects or modifies those options [518]. The displayed options are informed by Psychographic Data and Member Profile Data [522] which may include information on prior performance in the particular Walk behavior. The customization parameters [520] include the intensity of the activity such as the length of time or distance connected with a particular form of exercise. Also included are planned messages and environmental cues that can be used to trigger and sustain the activity. Finally, the parameters include specified performance goals and metrics, which can then be recorded and used to provide measures of progress in relation to the selected behavioral goals. The customization of each Walk is made fast and efficient by permitting the member to choose default options which are intelligently based on the member's preferences, profile data, and history with the Program.

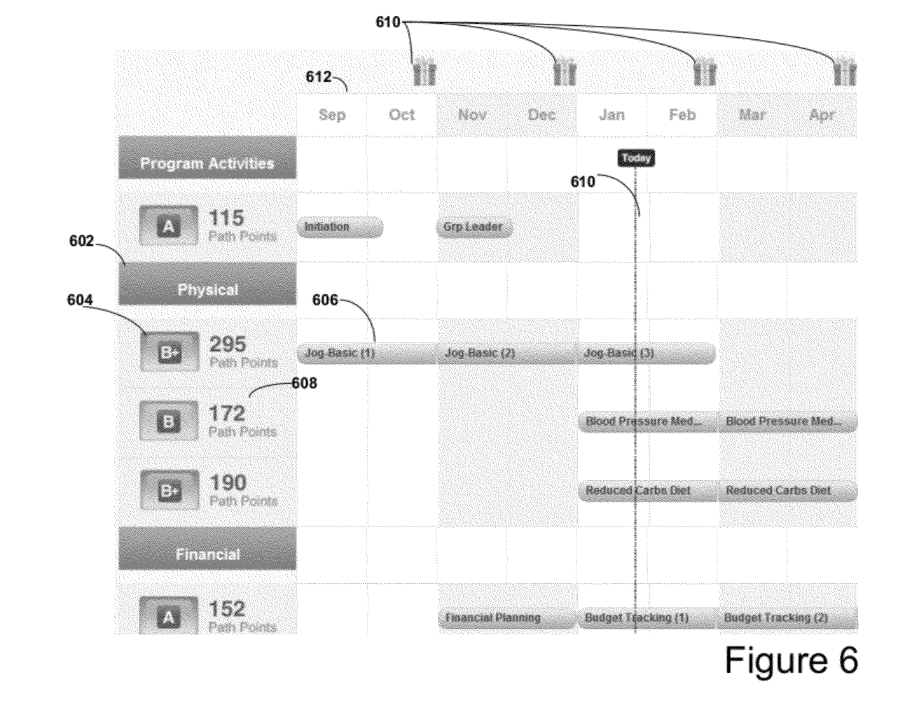

Once the Walks have been selected, the SHIP Software displays Calendar Views [524] of the selected Walks. A Weekly Walk View [530] shows the week's activities in relation to the member's chosen Walks. The Weekly Walk View, also displayable on mobile device, provides a mechanism for the member to report on a daily basis that schedule activities been completed and associated performance data, as relevant. In addition, the member can see an Annual Walk View which displays the selected Walks from the perspective of a year-long time span. [See also FIG. 6.]

The final step in the Walk Selection Process is the identification of groups, competitions, and other support for the persistence of engagement in the chosen behaviors [532]. There are groups associated with Walks, Paths, and Destinations. By default, the member is encouraged to join the groups associated with the member's Walks, Paths, and Destinations [534]. There is no specific obligation associated with group membership, but the member receives points for group participation. Similarly the member is encouraged to join Games and Competitions [536], with Points Associated with Participation, with points encouraging participation. Finally, the member may select receive other support in the form of information and coaching associated with the selected Walks [538]. As mentioned, the Program is designed to work with Disease Management and other services other services which may provide support and expertise connected with particular Walks, Paths, and Destinations.

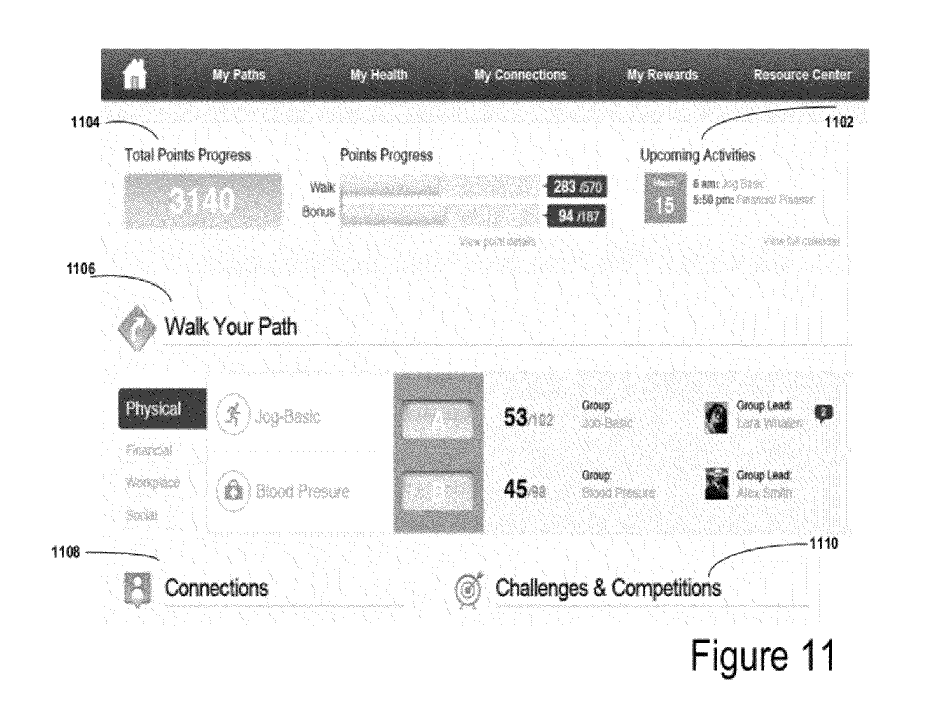

When the member completes the Walk selection process, the member is given access to the Member Dashboard (see FIG. 11), which provides a summary of key information the member requires to manage their participation in the program. This information includes notifications of upcoming activities [1102], total points earned through participation in the program [1104], the status of current Walks in relation to points earned during the Walk Period [1106], connections with other members and groups [1108], and the status of challenges and competitions [1110].

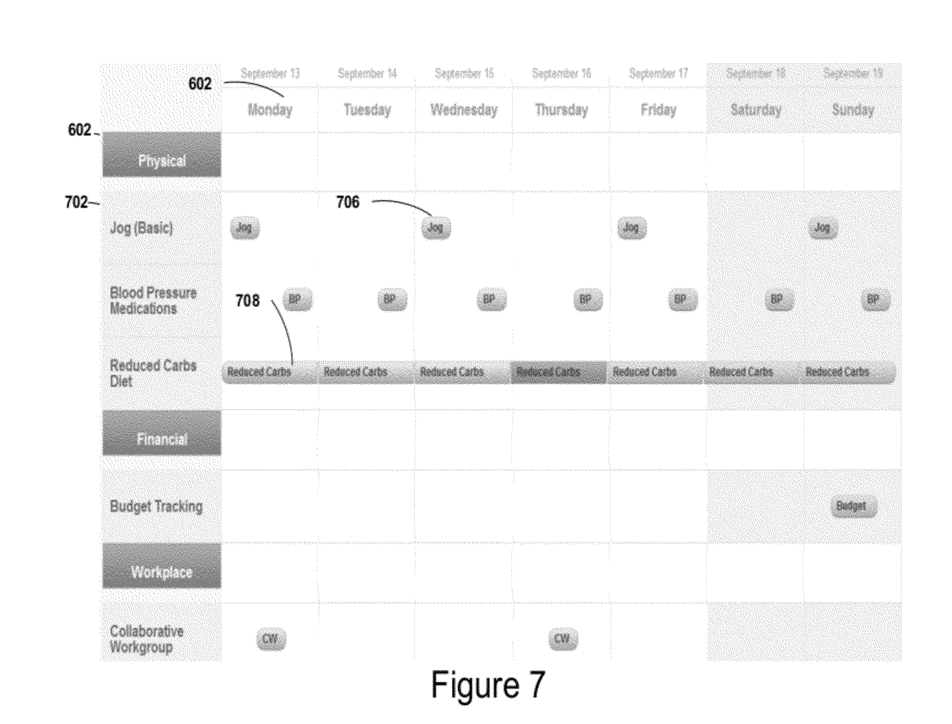

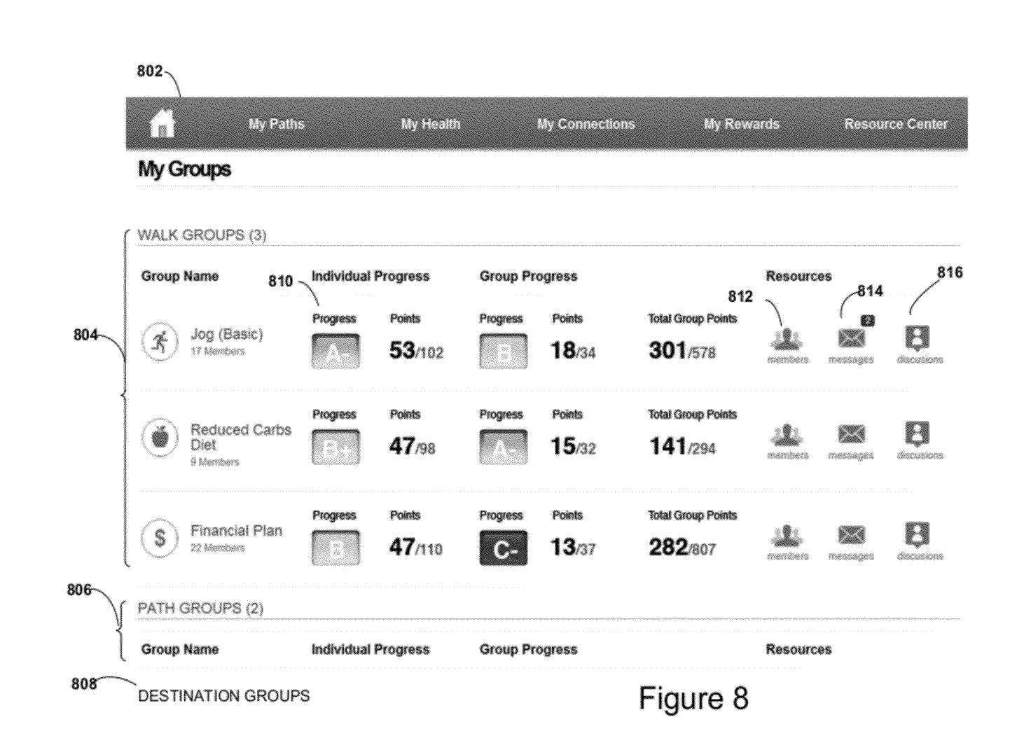

The member is also given access to four other views, which reflect his/her commitments to behavior change activities (Walks), the status of group memberships, and other critical information related to the member's participation. The Annual Walk View (See FIG. 6) shows the member's Walks in relation to the two-month long Walk Periods over the course of the current year. The Weekly Walk View (see FIG. 7) shows the member's commitments to activities scheduled to occur during the current week. The Group Dashboard (see FIG. 8) shows the member's associations with groups and related information. The fourth view, the Member Dashboard (see FIG. 11) summarizes status information related to member Walks, connections and communications, and the status of games and competitions.

In the Annual Walk View (FIG. 6), the member's Walks are shown in relation to the Award Periods beginning in September, November, January, March, May, and July. The Walks [606] are synchronized with these two-month intervals. The year-long calendar is shown at the top of the Annual Walk View [612]. The member sees the multiple dimensions [602], i.e., Walks related to Physical Health, Walks related to Financial Well-Being, Walks related to Workplace Engagement, Works related to Social Responsibility. The member also sees a grade [604], which reflects a measure of compliance in relation to each of the Walk activities. This grade is also visible to the Group Lead for the Walk groups to which the member belongs. The “wrapped-present” symbol at the top of the diagram [610] indicates the occurrence of an Award Event. As indicated, the Award Events occur at regular two-month intervals, simultaneous with the end of almost all Walks for all participants.

The Weekly Walk View (See FIG. 7) shows the member a view of the Walk activities [706] for each Walk, which the member selected at the beginning of the Award Period. As in the Annual Walk View, the Walks are divided into clusters [702] with respect to each of the four whole health dimensions [602]. In general, the walk activities occur over specific finite periods, as in the case of a specific exercise activity. In other cases that the Walk activity, may occur during the course of the day as in the case of the illustrated “Reduce Carbs Diet” [706]. The system attaches reporting processes to the individual events. With a mouse click, or finger press on the touchscreen, a pop-up window opens on the activity to allow for reporting on activity completion or an explanation of why the activity has not been completed. The window also provides an opportunity to provide performance measure data, such as the time required to carry out an exercise routine.

In contrast to existing techniques, which apply incentives to individual activities, the invention is structured to achieve a simplification and reduction of informational and decision-making requirements for the management of a given set of wellness activities. Because events occur cyclically over time, once the member is committed to a particular Walk, activities within that Walk are automatically triggered by mechanisms associated with the integrated calendar. The member is not making distinct decisions on whether to carry out each activity because the repetition of activities within the Walk because the member makes a commitment to carry out the Walk as a whole. That commitment to the aggregated behavior over the interval of the Modular Walk Period is reinforced by various social and incentive mechanisms supported by the SHIP Software. As shown in FIG. 6, multiple walks are also synchronized in relation to common ending points for Walk periods. These are structured to occur at regular intervals six times a year, with each approximately eight weeks in length. It because the Walks and at the same time for all members/participants the Award Events can act to increase the leverage and visibility of social and other incentives.

Support for Group Membership and Operations.

On completion of the Path Selection Process, the SHIP Software facilitates the member's connection to the social environment that supports the reliable execution of chosen Paths and Walks. More than a social environment involving communications among individuals and within randomly formed groups, the SHIP Software establishes an ordered structure of groups corresponding to the Walk-Path-Destination model. The connection of the member to the formal Groups entails of responsibilities and benefits associated with Group membership. Groups are associated with the Walks, Paths, and Destinations, and other areas of focus. When the member selects a Walk, he/she is automatically invited to join the associated Walk Group. The electronic message associated with the invitation outlines the benefits and responsibilities of group membership. Social science studies support the proposition that individuals are highly aware of the behavioral requirements for membership in a group. The Group membership process then takes advantage of the powerful incentive to conform to the behavioral patterns of the identified group. Other incentives, in the form of points, are attached to Group membership and associated activities. The Ship Software provides mechanisms to:
Identify groups associated with the member's chosen Walks, Paths, and Destination, to offer membership in the Groups to the member and to communicate requirements, expectations, and potential rewards associated with membership.
Facilitate intragroup communications via desktop, mobile, and other devices.
Provide security and privacy of intragroup communications including the establishment of private, confidential groups, ensuring the level of access to member information is controlled and monitored.
Establish the privileges and responsibilities of Group Leads, and provide for progressive training for leaders associated with Walk Groups, Path Groups, and Destination Groups.
Provide a system of gauges and displays (see FIG. 8) on multiple fixed and mobile devices to show status of aggregate group performance in relation to reward requirements, and status of groups in relation to competitions.

A special provision is made for a group that facilitates confidential communications and support. Called an “Inner Circle” group, this capability provides for group support in a private, secure environment. Like other groups supported with the Ship Software, the Inner Circle supports intergroup communications, discussions, and visibility of Path successes and progress. In addition, however, to normal group rules and expectations, Inner Circle groups contain additional rules restricting access to Inner Circle group member identities and providing for the needs of members with special needs for privacy of communications among Inner Circle group members Inner Circle groups are designed to support behaviors and conditions, including addictions, financial challenges, and other circumstances that members want to keep private. Members agree to the restricted terms and conditions of Inner Circle group membership.

As shown in FIG. 8, the Group Dashboard, both individual members and Group Leads are given access to communication capabilities and other functions relevant to group membership and functions associated with group associations. Group functions are accessed through the top menu [802] and other links in the SHIP Software application. Membership in the Walk Groups, Path Groups, and Destination Groups are shown in the clusters [804], [806], [808]. Members can then access information on members [812], messaging functions [814], and group discussions [816].

### System Operation and Context.

The SHIP Software operates within a flexible technical architecture that takes advantage of current and anticipated technologies that support web-based based delivery and of the SHIP application functions.

In the typical embodiment, the member will be using the SHIP Software to manage adopted Walks (behaviors) using a desktop computer or standard mobile device to receive and deliver information to the system. The member will employ standard web interfaces such as Internet Explorer, Firefox, Safari, or Chrome [902] to access the ship application environment. Certain functions supported by the SHIP Software environment will reside in the client side desktop or mobile device. These application functions are supported by standard technologies for interactive web applications [910]. The Mobile SHIP Platform [912] contains a somewhat reduced set of functionality designed to support real-time needs of the member/participant. These functions are designed to work with the Mobile SHIP Platform Resident on the Mobile Device [904], using standard mobile device operating systems, such as android and IOS. Both the desktop environment and the Mobile Platform can receive input from External Sensors and Devices [905], which may include information on blood pressure readings, visits to exercise facilities, position readings and velocity connected with exercise, devices in support of diagnostics, coaching and functions related to telemedicine.

The user interface devices (desktop, mobile, sensors) then communicate via the client application over appropriate communications channels [926] to the server environment. As in most web-based and mobile applications, client software is automatically updated over the Client/Server Communications channels. Communications are assumed to be asynchronous, with capabilities for client software to operate independent of continuous contact with the server environment.

In the typical case, the SHIP environment is deployed as a single instance for an identified employer. The server-side application [913] can reside either within the employer's data center or within Software-as-a-Service environment managed by the SHIP deployment administrator (the organization that manages the SHIP implementation for multiple client companies). This deployment can, of course, be replicated multiple times with implementations within the employer data centers, or be added as an additional instance in the software Software-as-a-Service environment.

There may be, of course, multiple Member Applications [914] in the Server Environment. In addition, the employer may have applications supporting such functions as health insurance [916]. These applications will interact with the administrative SHIP Software applications [918]. The Administrative SHIP Applications will include governance and reporting functions for the SHIP Program. These administrative applications will track member data, compliance with Walk commitments, administration of rewards and incentives, rules for Walk-Path-Destination selection, group discussions, communications, and other features of the SHIP Program social environment, business analytics and reporting to members and stakeholders in the SHIP Program, and other functions that ensure security, privacy, and compliance with employer and government rules and regulations. Data access and management functions [920] support interactions among the server applications (Member Applications, Employee Applications, Administrative SHIP Applications), and with External Services and Data Sources.

Key Mechanisms for Incentive Leverage and Persistence.

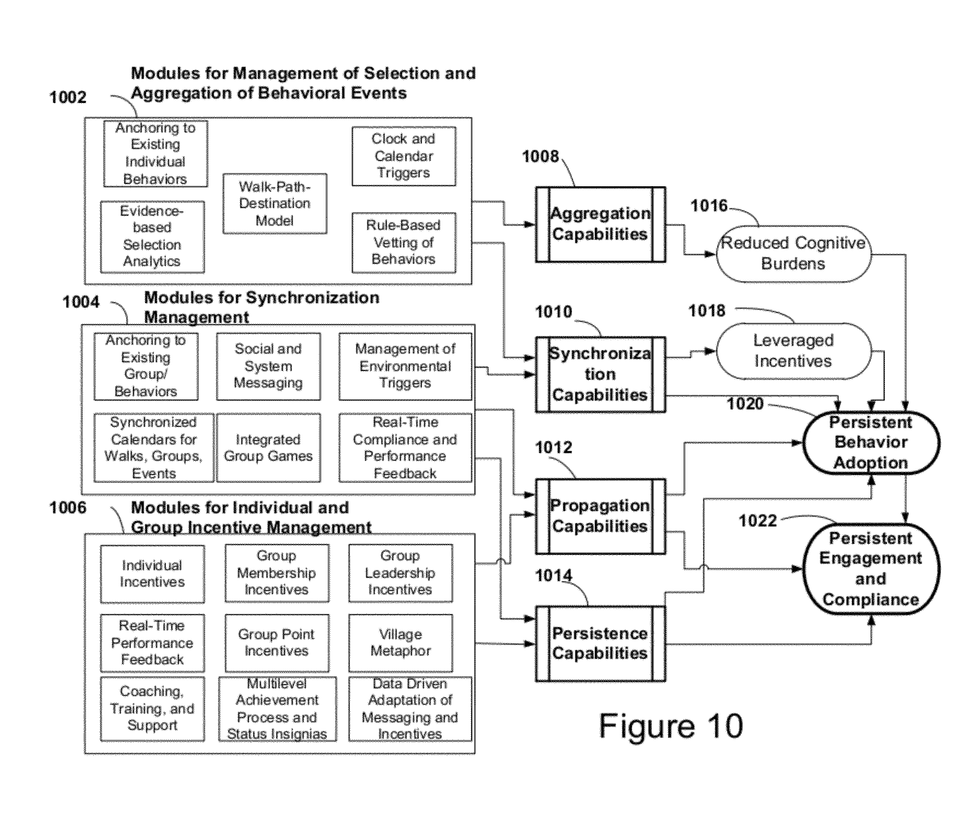

FIG. 10 summarizes the multiple mechanisms carried out within the SHIP Program and methodology that are designed to increase member/participant capabilities [1020] to adopt beneficial behaviors that persist over time. These capabilities on the part of individual members result in improved measures of persistent engagement (in the program) and compliance to committed beneficial behaviors [1022].

There are four principal mechanisms, which the invention employs to increase the impact (leverage) of incentives to produce the desired outcomes in relation to persistent behavior change. These principal mechanisms are referred to as the Aggregation Capabilities [1008], the Synchronization Capabilities [1010], the Propagation Capabilities [1012], and the Persistence Capabilities [1014]. The Aggregation Capabilities combine individual behavioral events into simpler cognitive units which can be vetted by SHIP Program experts and administrators and managed more easily by members. The Synchronization Capabilities enable individual and group behaviors (Walks) and awards to occur in coordinated time cycles. This acts to simplify informational requirements and management effort needed to manage behavioral change in large populations, leverages impact of incentives, and facilitates group visibility across the employee population. The Propagation Capabilities facilitate the replication of individual and group behaviors across the employee population, and in so doing, increases the efficiency of individual and group efforts. Finally, the Persistence Capabilities enable the application of specialized incentive strategies and support mechanisms to encourage persistent execution of adopted behaviors over an extended period of time.

Three main module groups support capabilities for Aggregation, Synchronization, Propagation, and Persistence, four key mechanisms are identified in the functional area, Modules for Management of Selection and Aggregation of Behavioral Events [1002]. The Walk-Path-Destination Model enables a rule/evidence-based selection of appropriate goals, paths, and behaviors defined as aggregated behavioral commitments (Walks) designed to occur over a designated eight-week interval followed by an Award Event for all members/participants in the SHIP Program. Regular event triggers (events on the Weekly Walk View calendar, messages and reminders) keep the member aware of behavioral commitments and associated reporting requirements, typically done on a daily basis. More importantly, the structure of the Walk makes it unnecessary for the member to make a decision regarding the activity, which becomes part of the regular Walk behavior. This is reinforced by the Anchoring to Existing Behaviors, the technique whereby new walk commitments are existing regular behaviors, as earlier described in the anchoring process. The Walk-Path-Destination model also permits systematic vetting of authorized behaviors (Rule-Based Vetting of Behaviors) so that only high-value behaviors in terms of risk reduction and other benefits are permitted in the SHIP Program environment.

The Modules for Synchronization Management [1004] promote the synchronization and propagation of high-value walk behaviors in the employee population. Similar to anchoring for individual behaviors in [1002], Anchoring to Existing Group/Organizational Behaviors [1004], ties individual Walks and Walk Groups, Path Groups and Destination Group events to existing organizational cycles and calendars. Social and System Messaging provides communications among the members within groups and synchronizes multiple groups that may be associated with a particular Paths. Such communications also encourages propagation of behaviors through mutual support mechanisms and, and access to information that may support similar Walks through coaching and access to informational resources. Environmental Cues and Triggers signals initiation of particular activities associated with Walks, as well as other events in the SHIP Program environment. Synchronized Calendars for Walks, Groups, and Award Events include multiple activities that are controlled by common calendars, in particular the six Award Events that mark the end of the regular Walk Periods. Integrated Group Games and Competitions are synchronized, again, to the Walk Periods, games and competitions tied to Award Events and synchronized to the Walk Periods. Real-Time Compliance and Performance Feedback provides information on compliance with individuals in relation to their Walk commitments as well as information on synchronization of group performance in relation to related groups. Such feedback can be provided on mobile devices in real-time.

The Modules for\ Individual and Group Incentives [1006] apply various individual and group incentives (guided by analytics on individual and group historical performance) to incentivize persistence and propagation of adopted beneficial behaviors. Recognizing that individual monetary incentives are often counterproductive to the adoption of habitual behaviors, the SHIP Program environment emphasizes group identity, group membership, and other forms of group association to motivate persistence. The SHIP Program manages points and awards given for participation in Walk, Path, and Destination Groups and imposes implied disincentives for those who may prevent the group from meeting its compliance requirements. In addition, special awards are provided for Group Leadership roles. Real-Time Performance Feedback on performance measures that have been established by the member or by rules-based recommendations from the Program. The Village Metaphor [FIG. 12] provides an alternative method for interacting with the member to provide access to functions in relation to village like locations. (See subsequent description). Additional help for individual compliance is provided by Coaching, Training, and Support, as required. Members are made aware of special awards given for particular levels of achievement defined by acquisition of award points (Multilevel Achievement Process and Status Insignias under [1006]. Finally, Data Driven Adaptation of Messaging and Incentives carries out customization of messaging and incentive strategies based upon psychographic data and compliance history.

These modules in combination produce capabilities for Aggregation of behavioral events [108], Synchronization of behaviors [1010], Propagation of behaviors across the population groups [1012], and enhanced Persistence Capabilities [1014]. These capabilities in turn reduce cognitive burdens [1016], leverage the impact of incentives [1018], adopt persistent behaviors [1020], and realize persistent engagement [1022], over an extended period of time.

### Embodiments of System Capabilities and User Interfaces

The SHIP Software and system may be implemented in the number of different system embodiments. Some of these have been discussed as in web application environments, company server environments, and mobile devices. One embodiment for the user interface has been described in relation to the Member Dashboard (FIG. 11). There may be other embodiments of the interface between SHIP Software functions and participating members One such alternative and body mint has been referenced as the Village Metaphor. This is described in FIG. 12. In this concept the member becomes part of a defined community in which he or she participates in various ways. The “village” in which the member resides supports the member's adoption of various improved behaviors via various services delivered at village locations. These locations include the Fitness Center [1202], the Community Center [1204], the Bank [1206], the Recreation Center [1208], the Village Clinic [1210], and the Library [1214]. The Fitness Center provide services directly related to the adoption and execution of behaviors (Walks). This involves health risk assessments, selection of behavioral commitments within the Walk-Path-Destination model, and carrying out and reporting on behavioral activities. At the Community Center, the member participates in groups and other activities connected with the community of participants or “village residents.” At the Bank, the member can check on the amount of points received in connection with awards, and perform various actions connected with reward accounting. At the Village Shopping Center the member can redeem reward points and obtain goods and services connection with the program. At the Village Recreation Center, the member can participate in games and competitions. At the Village Clinic, the member can receive specialized support from experts in the health and other behaviors, and also receive validation of report performance and diagnostics. At the Village Library, the member can obtain information relevant to participation in the program or other information related to behaviors in any of the four whole health dimensions.

What is claimed is:

1. A method creating a social environment for simultaneous, synchronized change of standard, vetted behaviors in large populations within employee organizations, said method comprising:
Assessing member/participant risks in relation to multiple dimensions affected by member/participant behaviors, including assessment of the member's capability to adopt persistent behaviors and change in existing behaviors as indicated by multiple psychographic measures of member preferences;
Creating a member profile to enable optimization of behavior change strategies and generation of valuable social connections to promote persistent behavior change;
Carrying out a process for behavior selection and commitment based on a Walk-Path-Destination model, according to which the member for selects Destinations reflecting the risk-based appropriate goals, then selects one or more Paths that lead to the goal, and then selects finite behavioral commitments (called “Walks”), which reduce or eliminate decision making during the execution of the walk
Supporting an automated process of membership in groups associated with the aforementioned Walk-Path-Destination model,
Carrying out a simple monitoring and verification process by which members can check off completion of Walks on a Weekly Walk View, verify activities that are completed and record measures of performance associated with the defined Walk.
Implementing a personalized incentive management system that rewards both individual compliance with behavioral commitments, as well as group participation, and other forms of achievement;
Aggregating member activities within finite Walks,
Synchronizing individual behaviors, Walks, Paths and associated groups in relation to the Program calendar and shared events across the whole population;
Propagating Walk behaviors with multiple mechanisms across the social networks defined by the Walk Groups, Path Groups, and Destination Groups, and other member to member associations;
Implementing a reporting process and governance structure to ensure that Walks and associated behaviors are appropriately authorized and supported with appropriate informal and expert communications;
Implementing a data analytics capability and learning process based on member data generated during the course of Walk engagement, and implementation of experimental designs with member population cohorts analyzed in relation to psychographic measures and differing environmental circumstances.

2. The method of claim 1 wherein the multiple dimensions include those of physical health, financial wellbeing, employment engagement and skills development, and social engagement and responsibility.

3. The method of claim 1 wherein the Walk-Path-Destination model defines standard Walks, which are 8-weeks in length, repeated at two-month intervals, permitting synchronization of Walk Periods for all members of the employee population;

4. The methods of claim 1 wherein the Walk-Path-Destination model, and methods of Aggregation, Synchronization, Propagation, reporting and incentivization can be applied to the multiple dimensions of physical health, financial well-being, employee engagement, and social responsibility, with little increased cost or management burden for members and administrators.

5. The method of claim 1 wherein selected walks are represented in an Annual Walk View and Weekly Walk View, which show synchronized Walks in the multiple dimensions, and tie Walks to standard, official clocks and calendars associated with the Program.

6. The method of claim 1 wherein that repetitive behavioral events contained within defined Walks are anchored to existing regular behaviors with a process that makes such existing behaviors visible to the member, and, in so doing, provides a mechanism to trigger such behaviors based upon existing regimens.

7. The method of claim 1 wherein the assessment of the member's capability to adopt persistent behaviors produces psychographic measures which can be employed to optimize incentive strategies, communications, and other support mechanisms to encourage persistence and link compliance to committed behaviors.

8. The method of claim 1 wherein Aggregation of behavioral events into Walks reduces cognitive and decision-making burdens for members and enables standardization of Walk modules (defined behavioral commitments) which can then be supported and replicated with repeatable, authorized processes.

9. The method of claim 1 wherein synchronizing individual behaviors, Walks, Paths and associated groups are supported by multiple mechanisms comprising:
Group Lead to member communications and member to member communications;
Methods to synchronize Walks in relation to performance measures, support mechanisms and associated groups across the organization.
Methods to synchronize incentive awards for both individual Walks and groups across the organization.
The use of games and competitions, synchronized with Walk completions.
The use of software-supported organization-wide Virtual Award Events, which take place at regular two-month intervals, to align individual Walks and achievements with group recognition and results of games and competitions.

10. The method of claim 1 where in Walk Groups may include special “inner circle groups” which operate under special privacy agreements enforced and monitored by the SHIP Software.

11. The method of claim 1, wherein incentives are coordinated with external services appropriate to selected Walk behaviors.

12. The method of claim 1, wherein the data analytics and experimental designs can be coordinated with the finite Walk Periods, which permit regular collection of data and experiments, based on standard data generation process is associated with the Walk Periods.

13. A system for facilitating the method of claim 1 comprising
various devices to acquire, analyze, and deliver information to members of the Program and other stakeholders;
a module to acquire member profile data on risks and psychographic metric metrics and analyze and apply such data to selection of Destinations, Paths, and Walks, activity scheduling and validation requirements;
A module to define and display existing regular behaviors, referred to as anchor behaviors, that form the member's matrix of current time use
a module to apply profile data to support member selection of appropriate Walks in relation to selected Destinations and Paths, and schedule Walk activities in relation to anchor behaviors;
a module to manage group membership and communications
a module to monitor, verify, and report on Walk activities, including display of performance measures and member progress;
a module to manage individual and group incentives, Including delivery, status and recognition level;
a Member Dashboard module to provide individuals and groups real-time information on the status of points and rewards, Walks, competitions, and other current data;
a Group Dashboard with real-time data to support group leadership functions in relation to the status of the compliance of group members, and information on current competitions, and access to key functions to support communications relevant to group functions;
A module to manage virtual Award Events, with appropriate communications and organization-wide visibility;
A module to synchronize groups and paths to optimize propagation of beneficial behaviors and support mechanisms across the organization;
A module to adapt information delivery and core functions to mobile devices over standard web and mobile device operating systems.

14. The system of claim 13 wherein devices to acquire, analyze, and delivered information include mobile devices with standard operating systems and specialized applications, external sensors to support transmission of diagnostic testing data, other platforms with standard web browsers and interactive web applications, the client-side application environment to support the Synchronized Health Incentive Platform software, a server platform for the server-side Synchronized Health Incentive Platform software, which may reside as an external Software-as-a-Service Application or within the employer organization's server environment, and interfaces to external services and data.

15. The system of claim 13 wherein the module for scheduling Walk activities in relation to anchor behaviors is configured to create a graphical representation of the relationship of new behaviors to existing individual, and in special cases, organizational “anchor” behaviors

16. The system of claim 13 wherein the group membership and communications module is configured to support group leadership functions, and support propagation of beneficial behaviors for communication of individual and group performance and successes.

17. The system of claim 13 wherein individual and group incentives module optimizes and repeatedly adapts incentive strategies based on individual and group psychographic characteristics and compliance history.

18. The system of claim 13 wherein the Group Dashboard and Member Dashboard are configured to provide real-time information with adaptations in relation to data requirements, language, educational level and other characteristics of the member's psychographic profile.

19. The system of claim 13 wherein the virtual Award Events are configured to enhance the visibility of individual and group rewards, high achievers, competition winners, to enable a virtual environment for organization-wide celebration of success in behavior change.
